(19) United States
(12) Patent Application Publication
(10) Pub. No.: US 2023/0081509 A1
(43) Pub. Date: Mar. 16, 2023

(54) COGNITIVE PROGRAMMING PARADIGM ASSISTANT

(71) Applicant: International Business Machines Corporation, Armonk, NY (US)

(72) Inventors: Indervir Singh Banipal, Austin, TX (US); Shikhar Kwatra, San Jose, CA (US); Stanley Bryan Hardter, Baldwinsville, NY (US); Seng Chai Gan, Ashburn, VA (US)

(21) Appl. No.: 17/477,161

(22) Filed: Sep. 16, 2021

(51) Int. Cl. G06N 5/04; G06N 5/02; G06F 8/30

(52) U.S. Cl. CPC G06N 5/04; G06N 5/022; G06F 8/30

(57) ABSTRACT

An approach is disclosed that ingests sets of metadata into an AI system utilizing a model trained to recognize a plurality of programming categories. Each of the sets of metadata corresponds to a computer programming language, and the ingested sets of metadata are stored in a corpus accessible by the AI system. A block of programming code is input to the AI system with the block including a number of computer instructions written in a computer programming language. Recommended programming languages are received from the AI system based on comparing the categories found in the block of programming code with the metadata corresponding to the recommended programming languages.

### BACKGROUND

A wide variety of computer programming languages are available to a computer programmer. Each programming language usually has particular strengths and particular challenges. In addition, new programming languages are continually being developed, often to serve a particular need or provide a set of particular strengths that might not be found in other programming languages. Programming languages can use imperative or declarative styles with each having the programmer provide different types of information. In addition, programming languages are often categorized as low-level programming style languages and high-level programming style languages, with each of these categories offering particular advantages and disadvantages to a computer programmer.

### SUMMARY

An approach is disclosed that ingests sets of metadata into an AI system utilizing a model trained to recognize a plurality of programming categories. Each of the sets of metadata corresponds to a computer programming language, and the ingested sets of metadata are stored in a corpus accessible by the AI system. A block of programming code is input to the AI system with the block including a number of computer instructions written in a computer programming language. Recommended programming languages are received from the AI system based on comparing the categories found in the block of programming code with the metadata corresponding to the recommended programming languages.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a high-level diagram depicting steps taken during cognitive programming assistance processing;

FIG. 4 is a depiction of a flowchart showing the logic used discover, mine, and map metadata corresponding to various programming languages; and

FIG. 5 is a depiction of a flowchart showing the logic used during user code analysis to analyze a user's code and recommend programming languages.

### DETAILED DESCRIPTION

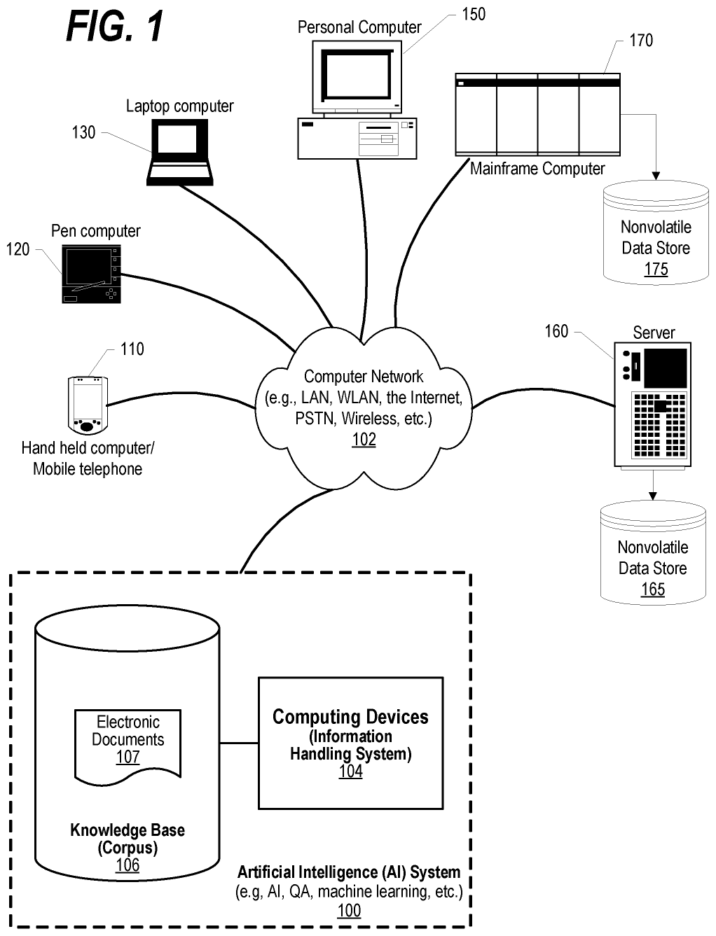

FIGS. 1-5 describe an approach to perform cognitive programming analysis. The approach provides an intelligent system which can learn and take following ameliorative actions: (a) The programming language which the user is using; and the functional goal which that language is trying to achieve through the user's commands and usage of APIs. For example. the system is able to say that the user is trying to read a file and do some processing on it. This could be inferred from the user's usage of file reading and processing APIs and functions. (b) The user's intention and the usage of the language to derive the actual processing which the user intends to do. For example, the system can observe and understand the user's actions and derive that the user wants to iterate the IMDB dataset and trying to filter out all the movies with 8+ ratings. (c) After a) and b) are done, the system is ready to say that for this particular type of processing which falls under big data analytics domain so if the user is using Java for this (as he is a regular backend engineer), the system might recommend the following: (Java, Imperative Programming) (Scala, Functional Programming). In this manner, the approach can recommend a better language and better programming paradigm based on the current user's actions and programming language (inputs caught from (a) and (b)).

Benefits of this approach include (a) Dynamic real-time system to help user become a better programmer/software engineer while designing and implementing systems; (b) Keep the programmer/engineer up to date with latest programming languages and paradigms; and (c) Benefit the product development team and the whole organization as a whole in designing and implementing better products.

The approach provides a method and system wherein: (a) The system trains over time to track different paradigms best suitable for different programming categories (programming categories are basically broader categories of types of programming or functions which have same programmatic goal). (b) The system detects the aggregated paradigm analytics being used by the user. (c) The system suggests appropriate paradigm for the user's usage based on user's history of programming categories and languages/programming used as compared with official language documentation and publicly available code repositories. (d) The system presents to the user, an appropriate method to improve the paradigm of the language being used, hence leading to a better quality of product. (e) The system presents to the user, an appropriate method to improve the language level (high or level language being used), hence leading to a better quality of product. (f) The system suggests appropriate level for the user's usage based on user's history of programming categories and languages/programming used. Where public code is available, it is presented to the developer for review.

System Design and Implementation. The approach identifies the programmatic action performed by the user (intended action): Here the approach utilizes the following technology in a sequential manner. a) Intent classification: When the user is generating text while programming using functions and APIs, from that generated text, the user intent is extracted out for further data mining and processing, so that the system can identify the possible programmatic action which the user is trying to perform. More about this is explained in the following step. In commented languages, the comments are also processed as they will likely reflect the developer's intent. b) Discovery & Mining, and Mapping: Each language has their own set of documentation and help section. The language specific information is mined from the help section of the language into enterprise search engine or content minor capabilities like Watson Discovery. This helps in extraction of relevant intended content from the corpus using QA/DeepQA technologies pertaining to that language.

Once the language specific documentation and help sections are ingested to Discovery, the next step is extracting relevant intent specific information using QA/DeepQA technologies. Each language's help/documentation corpus has some common standard attributes in them. For example, most major languages talk about the documentation to answer the following questions: How to iterate efficiently in this language? How to handle references (or maybe pointers)? How to perform file I/Os? How to perform error and exception handling?

All of the above information is extracted using relevant keywords using content mining enterprise engines like Watson Discovery which is basically an existing technology. The crucial part is the creation and mapping to the generic intents. Each of the extraction information sets is mapped against standard programming categories for the intents which have been created for this particular problem domain area. All the languages will have the generic programming categories such as Looping, Iterating, Exception handling, Filter/Map/Reduce, File I/O, etc.

Ground Truth Extraction by (Knowledge Discovery+SME labeling). Each programming category will have a certain programmatic goal completed in a specific way. For example, take the case of Filter/Map programming category. Filter/Map/Reduce functions can be performed in different languages different ways. With the combination of Knowledge Discovery+SME labeling, an internal ranking of paradigms for each programming category is prepared.

Knowledge Discovery corpus: For each programming category like filter/map/reduce, each language will have a certain set of documentation and features. For example. not much documentation about filter/map/reduce functions is found for C/C++ languages, however an abundance of such documentation about filter/map/reduce is found in Scala and other languages that tend to move towards declarative style of programming. If more knowledge has been mined by the knowledge discovery about this very specific capability (filter/map/reduce), the approach will push the corresponding language's ranking upwards for that particular programming category.

SME labeling: The initial phase of any intelligent system goes through ground truth preparation and knowledge creation. The system can crowd source to expert programmers, the relative scoring for these functions in any given language. For example. a programmer working on map-reduce in Scala is likely to rate a higher score for Scala for this very programming category than C/C++. In addition to labeling, SMEs can link out to shared repositories (one or more) of existing public code (Git) that shows language-to-function that has been developed as a solution to real use cases. SME labeling can help prove that the language-to-function can work in the field, and will therefore will lead to higher scoring (ranking) for this language in the corresponding category.

If the top languages of the programming category are declarative, then the programming category is marked as declarative. The scoring is multi-dimensional for example. for Filter/Map/Reduce programming category, it is:

“declarative”: 0.80,

“imperative”: 0.15,

“procedural”: 0.03,

Real-time monitoring user's usage programming categories and recommending paradigm is performed by the approach based on the above metrics. The user is shown the resulting analytics and programming language recommendations. The majority and most used programming categories used by the user are favorably compared to the most highly ranked languages in those programming categories.

FIG. 1 depicts a schematic diagram of one illustrative embodiment of artificial intelligence (AI) system 100 in a computer network 102. AI system 100 includes artificial intelligence computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable functionality, such as question/answer (QA) generation functionality, for one or more content users. Other embodiments of AI system 100 may be used with components, systems, sub-systems, and/or devices other than those that are depicted herein.

AI system 100 maintains knowledge base 106, also known as a “corpus,” which is a store of information or data that the AI system draws on to solve problems. This knowledge base includes underlying sets of facts, assumptions, models, and rules which the AI system has available in order to solve problems.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that artificial intelligence 100 may operate in environments of any size, including local and global, e.g., the Internet. Additionally, artificial intelligence 100 serves as a front-end system that can make available a variety of knowledge extracted from or represented in documents, network-accessible sources and/or structured data sources. In this manner, some processes populate the artificial intelligence with the artificial intelligence also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and, in one embodiment, may input questions to AI system 100 that may be answered by the content in the corpus of data. As further described below, when a process evaluates a given section of a document for semantic content, the process can use a variety of conventions to query it from the artificial intelligence.

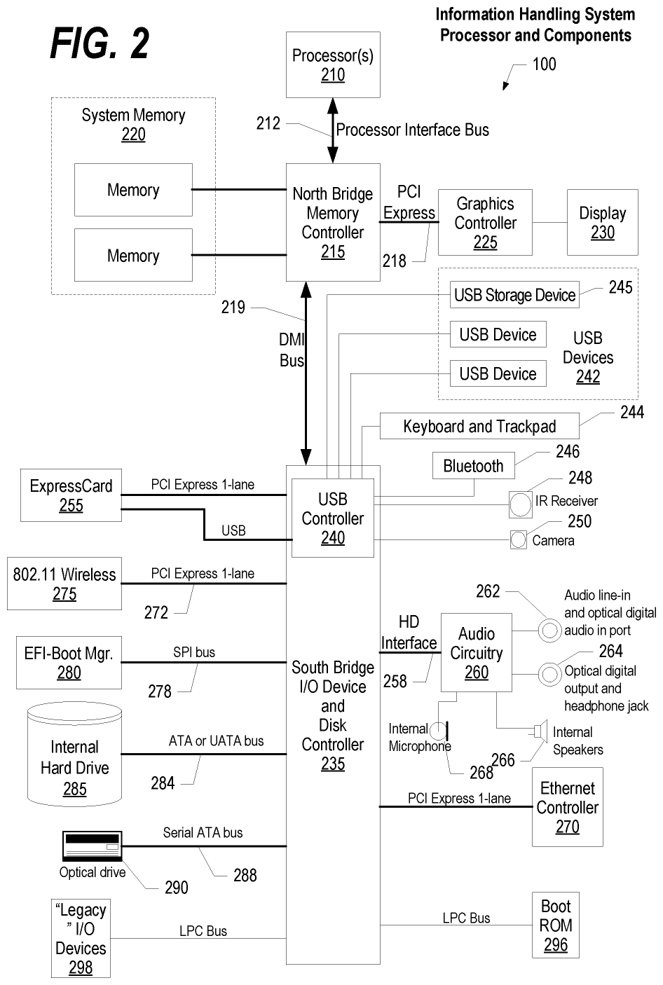

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

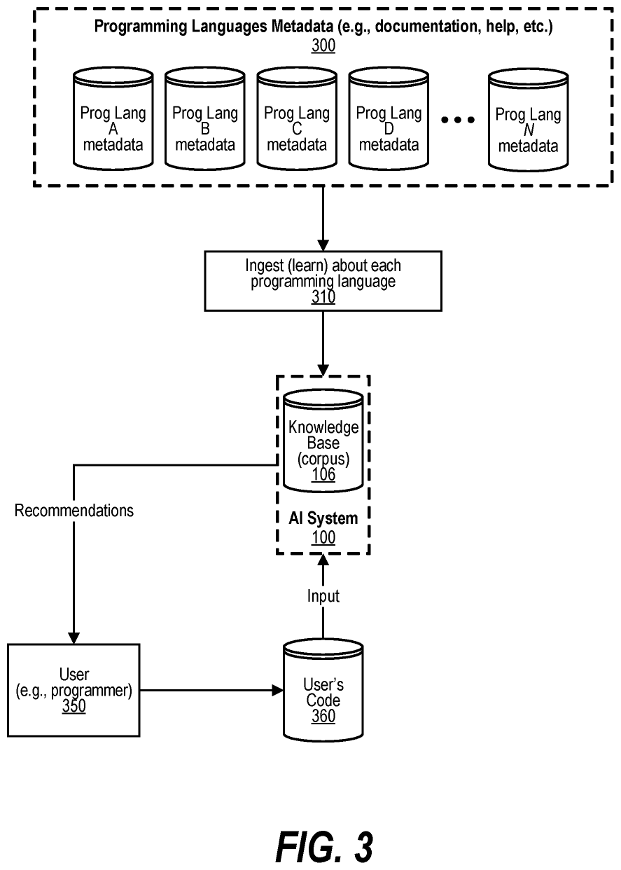

FIG. 3 is a high-level diagram depicting steps taken during cognitive programming assistance processing. Metadata 300, such as online documentation, help files, etc., is identified for any number of programming languages. At step 310, the process ingests, or learns, about the various programming files and stores the metadata associated with the various programming languages in corpus 106. Metadata includes programming categories associated with each of the programming languages as well as an internal ranking of how well each programming language handles the various programming categories. For example, one programming category might be “file I/O” and a first programming language might handle file I/O quite well and, therefore, this category would be highly ranked for this programming language. On the other hand, another programming language might have limited file I/O capabilities and, consequently, be ranked lower in terms of file I/O capabilities.

User 350, such as a programmer, software developer, or the like, prepares a block of programming code in a particular programming language with the block containing any number of computer program instructions. This block of code is stored in data store 360. AI system 100, using the training of an AI system model and the knowledge base ingested into corpus 106 from metadata 300 previously ingested and corresponding to the variety of programming languages compares the metadata and programming categories found in the user's block of code from data store 360 with the metadata and categories with handling data (e.g., ranking, etc.) associated with the variety of programming languages. This AI processing results in an analysis and set of recommendation returned to user 350. The recommendations may include one or more programming languages different from the language used to create the user's code block. These recommendations are based on how well the recommended programming languages handle the programming categories found in the user's code block stored in data store 360. In addition, the recommendations can provide an analysis of the various programming categories found in the user's block of code and a comparison of those programming categories with programming languages found to better handle such programming categories.

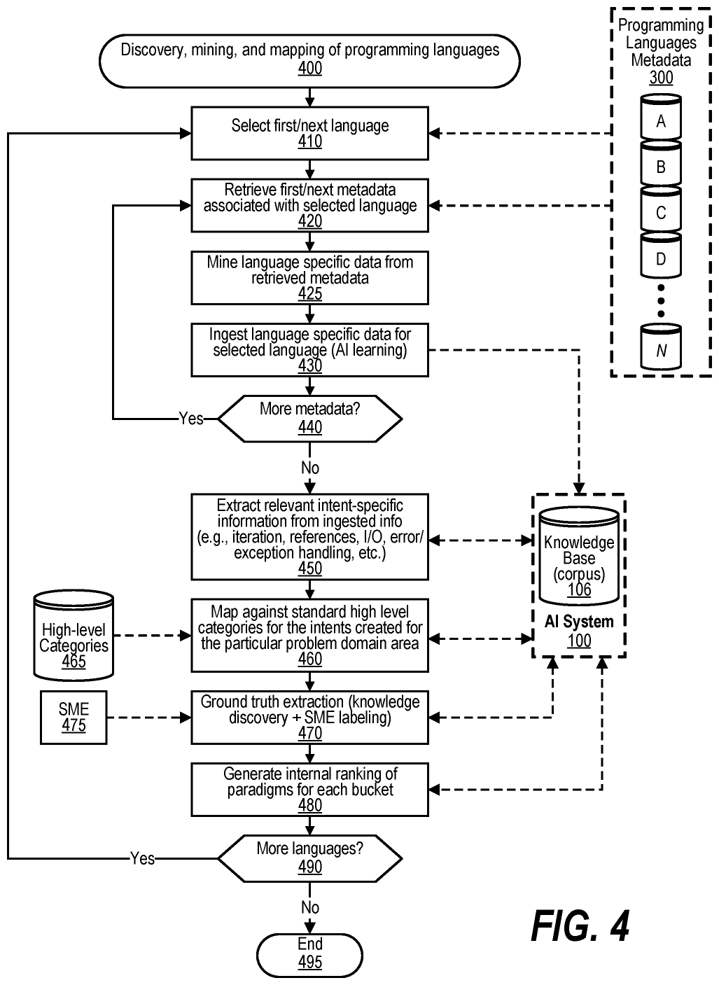

FIG. 4 is a depiction of a flowchart showing the logic used discover, mine, and map metadata corresponding to various programming languages. The data that is discovered, mined, and mapped is used to train a model utilized by AI system 100 with the model stored in corpus 106 as well as ingesting metadata regarding various programming languages with the metadata including programming categories and a ranking of how well each programming language handles each of the programming categories such as Looping, Iterating, Exception handling, Filter/Map/Reduce, File I/O, etc.

FIG. 4 processing commences at 400 and shows the steps taken by a process that performs discovery, mining, and mapping of programming languages in order to train AI system 100. At step 410, the process selects the first programming language for processing. At step 420, the process retrieves the first set of metadata associated with the selected language from online sources 300. At step 425, the process mines programming language specific data from retrieved metadata. At step 430, the process ingests the language specific data for the selected language (e.g., AI learning, etc.) with the language specific metadata ingested into corpus 106 and the language specific data being used to the model used by AI system 100.

The process determines as to whether there is more metadata to process for the selected programming language (decision 440). If there is more metadata to process for the selected programming language, then decision 440 branches to the ‘yes’ branch which loops back to step 420 to continue retrieving, mining, and ingesting more language specific data and metadata into AI system corpus 106 and continue training the AI system's model. This looping continues until there is no more metadata to process for the selected programming language, at which point decision 440 branches to the ‘no’ branch exiting the loop.

At step 450, the process extracts relevant intent-specific information (metadata) from the data corresponding to the selected programming language that was ingested info the AI system's corpus 106. This relevant intent-specific information includes information such as iteration handling information, references handling information, I/O handling information, error/exception handling information, and the like.

At step 460, the process maps the extracted relevant intent-specific information found in step 450 against standard high-level program categories for the intents created for the particular problem domain area. The programming categories data is retrieved from data store 465. This mapping of programming categories to relevant intent-specific information is ingested into corpus 106 and used to further train the model used by AI system 100.

At step 470, the process extracts ground truth information including knowledge discovery subject matter expert (SME) labeling. In one embodiment, the ground truth information and SME labeling are retrieved from one or more Subject Matter Experts (SMEs) 475. This ground truth knowledge and SME labeling is also ingested into corpus 106 and used to further train the model used by AI system 100.

At step 480, the process generates an internal ranking of paradigms for each of the software categories associated with the selected programming language. This ranking data is ingested into corpus 106 and is further used to train the model used by AI system 100 on how well the selected language handles each of the various program categories.

The process determines as to whether there are more languages to process (decision 490). If there are more languages to process, then decision 490 branches to the ‘yes’ branch which loops back to step 410 to select and process the next programming language as described above. This looping continues until there are no more languages to process, at which point decision 490 branches to the ‘no’ branch exiting the loop and the discover, mining, and mapping process ends at 495.

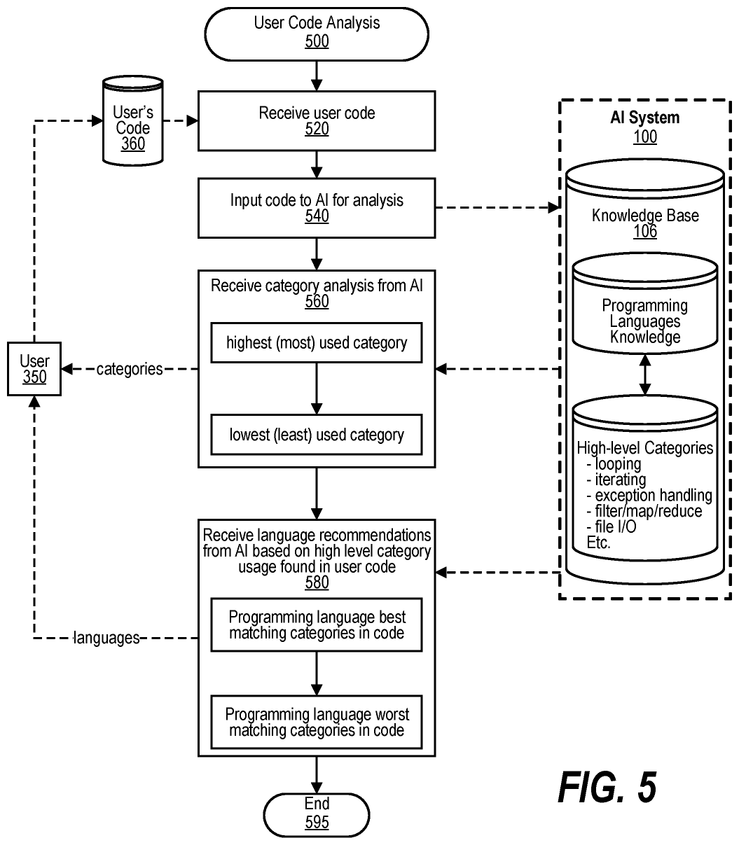

FIG. 5 is a depiction of a flowchart showing the logic used during user code analysis to analyze a user's code and recommend programming languages. FIG. 5 processing commences at 500 and shows the steps taken by a process that performs user code analysis on a user's code to recommend alternate programming languages based on the type of programming (program categories) found in the user's code.

At step 520, the process receives user code. The user's code is retrieved from data store 360 and includes a block of programming code that includes any number of computer instructions written in a first computer programming language. At step 540, the process inputs the user's block of code to AI system 100 for analysis.

At step 560, the process receives a programming category analysis from AI system 100. This analysis includes the programming category that was the most found in the user's code to the programming category that was least found. In one embodiment, the ranking from most to least is in terms of the size of the user's code that corresponded with each of the particular programming categories.

At step 580, the process receives one or more programming language recommendations from AI system 100 based on the AI system's comparing of the programming category usage found in the user's code with the handling of those programming categories found in the variety of available programming languages that was learned by the AI system during the learning and ingesting processing shown in FIG. 4. The category analysis data and the programming language recommendation data are provided to user 350 for the user's consideration. FIG. 5 processing of the user's code analysis thereafter ends at 595.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method, implemented by an information handling system that includes a processor and a memory, the method comprising:
ingesting a plurality of sets of metadata into an artificial intelligence (AI) system utilizing a model trained to recognize a plurality of programming categories, wherein each of the sets of metadata corresponds to one of a plurality of computer programming languages, and wherein the ingested sets of metadata are stored in a corpus accessible by the AI system;
inputting, to the AI system utilizing the trained model, a block of programming code that includes a plurality of computer instructions written in a first computer programming language; and
receiving, from the AI system, one or more recommended programming languages based on a comparison of a first set of programming categories found in the block of programming code and the metadata corresponding to the one or more recommended programming languages.

2. The method of claim 1 wherein the ingesting further comprising:
selecting one of the plurality of programming languages;
retrieving a set of online documentation corresponding to the selected programming language;
mining the set of metadata corresponding to the selected programming language from the set of online documentation;
extracting one or more of the programming categories from the online documentation, wherein the programming categories are identified from intent-specific portions of the online documentation; and
associating the extracted programming categories with the selected programming language in the corpus utilized by the AI system.

3. The method of claim 2 further comprising:
receiving a set of ground truth data associated with the selected programming language from a subject matter expert (SME); and
training the AI system with the associated extracted programming categories and the set of ground truth data.

4. The method of claim 1 further comprising:
generating an internal ranking of one or more programming categories associated with each of the plurality of programming languages, wherein the internal ranking identifies a relative strength of the respective programming languages with regard to each of the one or more associated programming categories; and
further comparing the internal ranking of the programming categories associated with each of the plurality of programming languages with the first set of programming categories found in the block of programming code, the comparing resulting in the one or more recommended programming languages.

5. The method of claim 4 further comprising:
ranking the one or more recommended programming languages, the ranking further comprising:
identifying a size of the plurality of computer instructions in the block of programming code associated with each of the first set of programming categories; and
ranking the first set of programming categories based on the size identified for each of the first set of programming categories, the ranking resulting in a ranked first set of programming categories, wherein the comparing further compares the ranked first set of programming categories with the internal ranking of the programming categories associated with each of the plurality of programming languages.

6. The method of claim 1 further comprising:
outputting, from the AI system, a code analysis corresponding to the block of programming code, wherein the code analysis includes a ranked list of the first set of programming categories found in the block of programming code; and
providing the code analysis and the one or more recommended programming languages to a user associated with the block of programming code.

7. The method of claim 1 wherein at least one of the programming categories is selected from the group consisting of iteration handling, reference handling, input-output handling, error exception handling, and filter-map-reduce handling.

8. An information handling system comprising:
one or more processors;
a memory coupled to at least one of the processors;
a set of computer program instructions stored in the memory and executed by at least one of the processors in order to perform actions comprising:
ingesting a plurality of sets of metadata into an artificial intelligence (AI) system utilizing a model trained to recognize a plurality of programming categories, wherein each of the sets of metadata corresponds to one of a plurality of computer programming languages, and wherein the ingested sets of metadata are stored in a corpus accessible by the AI system;
inputting, to the AI system utilizing the trained model, a block of programming code that includes a plurality of computer instructions written in a first computer programming language; and
receiving, from the AI system, one or more recommended programming languages based on a comparison of a first set of programming categories found in the block of programming code and the metadata corresponding to the one or more recommended programming languages.

9. The information handling system of claim 8 wherein the ingesting actions further comprise:
electing one of the plurality of programming languages;
retrieving a set of online documentation corresponding to the selected programming language;
mining the set of metadata corresponding to the selected programming language from the set of online documentation;
extracting one or more of the programming categories from the online documentation, wherein the programming categories are identified from intent-specific portions of the online documentation; and
associating the extracted programming categories with the selected programming language in the corpus utilized by the AI system.

10. The information handling system of claim 9 wherein the actions further comprise:
receiving a set of ground truth data associated with the selected programming language from a subject matter expert (SME); and
training the AI system with the associated extracted programming categories and the set of ground truth data.

11. The information handling system of claim 8 wherein the actions further comprise:
generating an internal ranking of one or more programming categories associated with each of the plurality of programming languages, wherein the internal ranking identifies a relative strength of the respective programming languages with regard to each of the one or more associated programming categories; and
further comparing the internal ranking of the programming categories associated with each of the plurality of programming languages with the first set of programming categories found in the block of programming code, the comparing resulting in the one or more recommended programming languages.

12. The information handling system of claim 11 wherein the actions further comprise:
ranking the one or more recommended programming languages, the ranking wherein the actions further comprise:
identifying a size of the plurality of computer instructions in the block of programming code associated with each of the first set of programming categories; and
ranking the first set of programming categories based on the size identified for each of the first set of programming categories, the ranking resulting in a ranked first set of programming categories, wherein the comparing further compares the ranked first set of programming categories with the internal ranking of the programming categories associated with each of the plurality of programming languages.

13. The information handling system of claim 8 wherein the actions further comprise:
outputting, from the AI system, a code analysis corresponding to the block of programming code, wherein the code analysis includes a ranked list of the first set of programming categories found in the block of programming code; and
providing the code analysis and the one or more recommended programming languages to a user associated with the block of programming code.

14. The information handling system of claim 8 wherein at least one of the programming categories is selected from the group consisting of iteration handling, reference handling, input-output handling, error exception handling, and filter-map-reduce handling.

15. A computer program product stored in a computer readable storage medium, comprising computer program code that, when executed by an information handling system, performs actions comprising:
ingesting a plurality of sets of metadata into an artificial intelligence (AI) system utilizing a model trained to recognize a plurality of programming categories, wherein each of the sets of metadata corresponds to one of a plurality of computer programming languages, and wherein the ingested sets of metadata are stored in a corpus accessible by the AI system;
inputting, to the AI system utilizing the trained model, a block of programming code that includes a plurality of computer instructions written in a first computer programming language; and
receiving, from the AI system, one or more recommended programming languages based on a comparison of a first set of programming categories found in the block of programming code and the metadata corresponding to the one or more recommended programming languages.

16. The computer program product of claim 15 wherein the ingesting actions further comprise:
selecting one of the plurality of programming languages;
retrieving a set of online documentation corresponding to the selected programming language;
mining the set of metadata corresponding to the selected programming language from the set of online documentation;
extracting one or more of the programming categories from the online documentation, wherein the programming categories are identified from intent-specific portions of the online documentation; and
associating the extracted programming categories with the selected programming language in the corpus utilized by the AI system.

17. The computer program product of claim 16 wherein the actions further comprise:
receiving a set of ground truth data associated with the selected programming language from a subject matter expert (SME); and
training the AI system with the associated extracted programming categories and the set of ground truth data.

18. The computer program product of claim 15 wherein the actions further comprise:
generating an internal ranking of one or more programming categories associated with each of the plurality of programming languages, wherein the internal ranking identifies a relative strength of the respective programming languages with regard to each of the one or more associated programming categories; and
further comparing the internal ranking of the programming categories associated with each of the plurality of programming languages with the first set of programming categories found in the block of programming code, the comparing resulting in the one or more recommended programming languages.

19. The computer program product of claim 18 wherein the actions further comprise:
ranking the one or more recommended programming languages, the ranking wherein the actions further comprise:
identifying a size of the plurality of computer instructions in the block of programming code associated with each of the first set of programming categories; and
ranking the first set of programming categories based on the size identified for each of the first set of programming categories, the ranking resulting in a ranked first set of programming categories, wherein the comparing further compares the ranked first set of programming categories with the internal ranking of the programming categories associated with each of the plurality of programming languages.

20. The computer program product of claim 15 wherein the actions further comprise:
outputting, from the AI system, a code analysis corresponding to the block of programming code, wherein the code analysis includes a ranked list of the first set of programming categories found in the block of programming code; and
providing the code analysis and the one or more recommended programming languages to a user associated with the block of programming code.
